(19) United States
(12) Patent Application Publication
(10) Pub. No.: US 2025/0225662 A1
(43) Pub. Date: Jul. 10, 2025

(54) REVERSE DISPARITY ERROR CORRECTION

(71) Applicant: QUALCOMM Incorporated, San Diego, CA (US)

(72) Inventors: Jamie Menjay LIN, San Diego, CA (US); Jisoo JEONG, San Diego, CA (US); Fatih Murat PORIKLI, San Diego, CA (US); Kai WANG, San Diego, CA (US)

(21) Appl. No.: 18/405,841

(22) Filed: Jan. 5, 2024

(51) Int. Cl. G06T 7/246; G06T 3/18

(52) U.S. Cl. CPC G06T 7/248; G06T 3/18; G06T 2207/10012; G06T 2207/20081; G06T 2207/20084

(57) ABSTRACT

Disclosed are systems and techniques for capturing images (e.g., using an image capture) and performing reverse optical flow error correction. According to some aspects, a computing system or device can obtain first disparity information associated with a current image. The first disparity information estimates a first movement of a first feature to a first destination location in the current image. The computing system or device can warp the current image based on the first disparity information to obtain an estimated previous image, determine a confidence map associated with a confidence of the first disparity information based on a difference associated with the estimated previous image; and apply the confidence map to the first disparity information to generate updated first disparity information.

### FIELD

The present application is related to processing images. For example, according to some aspects, systems and techniques are described for correcting errors in disparity information (e.g., optical flow information, depth information, etc.) with reverse optical flow error correction.

### BACKGROUND

Multimedia systems are widely deployed to provide various types of multimedia communication content such as voice, video, packet data, messaging, broadcast, and so on. These multimedia systems may be capable of processing, storage, generation, manipulation, and rendition of multimedia information. Examples of multimedia systems include mobile devices, game devices, entertainment systems, information systems, virtual reality systems, model and simulation systems, and so on. These systems may employ a combination of hardware and software technologies to support the processing, storage, generation, manipulation, and rendition of multimedia information, for example, client devices, capture devices, storage devices, communication networks, computer systems, and display devices.

### SUMMARY

Systems and techniques can be used for correcting errors in disparity information with reverse optical flow error correction. According to at least one example, a method includes: obtaining first disparity information associated with a current image, the first disparity information estimating a first movement of a first feature to a first destination location in the current image; warping the current image based on the first disparity information to obtain an estimated previous image; determining a confidence map associated with a confidence of the first disparity information based on a difference associated with the estimated previous image; and applying the confidence map to the first disparity information to generate updated first disparity information.

In another example, an apparatus for processing one or more images is provided that includes one or more memories configured to store the one or more images and one or more processors (e.g., implemented in circuitry) coupled to the one or more memories and configured to: obtain first disparity information associated with a current image, the first disparity information estimating a first movement of a first feature to a first destination location in the current image; warp the current image based on the first disparity information to obtain an estimated previous image; determine a confidence map associated with a confidence of the first disparity information based on a difference associated with the estimated previous image; and apply the confidence map to the first disparity information to generate updated first disparity information.

In another example, a non-transitory computer-readable medium is provided that has stored thereon instructions that, when executed by one or more processors, cause the one or more processors to: obtain first disparity information associated with a current image, the first disparity information estimating a first movement of a first feature to a first destination location in the current image; warp the current image based on the first disparity information to obtain an estimated previous image; determine a confidence map associated with a confidence of the first disparity information based on a difference associated with the estimated previous image; and apply the confidence map to the first disparity information to generate updated first disparity information.

In another example, an apparatus for processing one or more images is provided. The apparatus includes: means for obtaining first disparity information associated with a current image, the first disparity information estimating a first movement of a first feature to a first destination location in the current image; means for warping the current image based on the first disparity information to obtain an estimated previous image; means for determining a confidence map associated with a confidence of the first disparity information based on a difference associated with the estimated previous image; and means for applying the confidence map to the first disparity information to generate updated first disparity information.

In some aspects, one or more of the apparatuses described herein is, is part of, and/or includes a wireless communication device, a mobile device (e.g., a mobile telephone and/or mobile handset and/or so-called “smartphone” or another mobile device), an extended reality (XR) device (e.g., a virtual reality (VR) device, an augmented reality (AR) device, or a mixed reality (MR) device) such as a head-mounted device (HMD) device, a vehicle or a computing device or component of a vehicle, a wearable device, a camera, a personal computer, a laptop computer, a server computer, another device, or a combination thereof. In some aspects, the one or more apparatuses include a camera or multiple cameras for capturing one or more images. In some aspects, the one or more apparatuses include a display for displaying one or more images, notifications, and/or other displayable data. In some aspects, the one or more apparatuses can include one or more sensors (e.g., one or more inertial measurement units (IMUs), such as one or more gyroscopes, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1A, FIG. 1B, and FIG. 1C are diagrams illustrating example configurations for an image sensor of an image capture device, in accordance with aspects of the present disclosure.

FIG. 2 is a block diagram illustrating an architecture of an image capture and processing device, in accordance with aspects of the present disclosure.

FIG. 3 is a block diagram illustrating an example of an image capture system, in accordance with aspects of the present disclosure.

FIG. 4 is a conceptual diagram of an optical flow correction system that provides reverse optical flow error correction, in accordance with some aspects of the disclosure.

FIG. 5 is a block diagram of an optical flow correction system configured to perform reverse optical flow error correction, in accordance with some aspects of the disclosure.

FIG. 6A is a conceptual illustration of an optical flow between two images and an error that can be introduced, in accordance with some aspects of the disclosure.

FIG. 6B is a conceptual illustration of an estimated previous image and identification of an error, in accordance with some aspects of the disclosure.

FIG. 6C is a conceptual illustration of a confidence map that can be used by an cleaning engine to remove an error introduced in optical flow, in accordance with some aspects of the disclosure

FIG. 6D is a conceptual illustration of a cleaned optical flow, in accordance with some aspects of the disclosure.

FIGS. 7A-7C are illustrations of examples of optical flow without a ground truth, optical flow without reverse optical flow error correction, and optical flow with reverse optical flow error correction, in accordance with some aspects of the disclosure.

FIG. 8 is a flowchart illustrating an example method for capturing images in low light conditions, in accordance with aspects of the present disclosure.

FIG. 9 is an illustrative example of a deep learning neural network that can be used to implement the machine learning-based alignment prediction, in accordance with aspects of the present disclosure.

FIG. 10 is an illustrative example of a convolutional neural network (CNN), in accordance with aspects of the present disclosure.

FIG. 11 is a diagram illustrating an example of a system utilizing optical flow to encode video frames.

FIG. 12 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures images, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as ISO, exposure time, aperture size, f/stop, shutter speed, focus, and gain. For example, settings or parameters can be applied to an image sensor for capturing the one or more image frames. Other camera settings can configure the post-processing of one or more image frames, such as alterations to contrast, brightness, saturation, sharpness, levels, curves, or colors. For example, settings or parameters can be applied to a processor (e.g., an image signal processor (ISP)) for processing the one or more image frames captured by the image sensor.

Images can be used for various disparity estimation applications for determining disparity information, such as optical flow estimation for determining disparity information and stereo depth estimation for determining depth information. For example, one use of an image from a camera is detection of motion within the image or detection of motion of a device including the camera using optical flow. Optical flow is a representation of motion patterns between images (e.g., consecutive i310mages) of a sequence of images. For example, optical flow can enable algorithms to track the movement of pixels by comparing their intensities between images. Optical flow can be useful for understanding how objects or points in an image move over time. For instance, in the context of two sequential images, optical flow can estimate the displacement of pixels between the images, providing valuable information about apparent motion in the scene. For example, a camera used to capture images can be in a fixed position on a device (e.g., a mobile device or vehicle) and optical flow between the images can provide information pertaining to movement of the device or movement within the environment, such as movement of the device within the environment.

In some cases, based on an optical flow determination between a first image and a second image, an optical flow vector can be determined for one or more pixels in the second image. For instance, a dense optical flow map can include an optical flow vector for each pixel in an image, with all pixels in the image being represented by an optical flow vector. The optical flow vector for a pixel can indicate the direction and magnitude of a pixel movement from a first time at which the first image is captured to a second time at which the second image is captured.

Images can also be used to determine depth information. For example, a first camera can be used to capture a first image of a scene and a second camera can be used to capture a second image of the scene. Stereo depth estimation can be performed to determine depth information from the first and second images. The depth information can represent the distance between the first and/or second cameras and one or more objects depicted in the images. Depth is inversely proportional to disparity and disparity is proportional to a baseline distance between the first and second cameras. The more the disparity is, the closer the object is to the baseline of the cameras. The less the disparity is, the farther the object is to the baseline.

Disparity estimation applications (e.g., optical flow, stereo depth estimation, etc.) can be useful for many tasks, such as surveillance systems, robotics, autonomous or semi-autonomous vehicles (e.g., for autonomous or semi-autonomous navigation), video analysis, and so forth. For example, optical flow can be used to track the trajectory and/or detect motion of objects, recognize events in the environment (e.g., to understand and respond to the events in the environment), among others. In another example, optical flow can also be used to improve video stabilization, image interpolation, image correction, extended reality (XR) applications, among others.

Optical flow has many challenges, such as in environments with local inconsistencies due to illumination changes, occlusion, complex motion patterns, etc. Local inconsistencies are errors that are a result of local variations such as pixel intensity caused by texture, shading, or occlusions. For example, an object that is occluded in one image and visible in a subsequent image can create errors in the optical flow between the images. In some cases, optical flow algorithms can assume that the motion between consecutive images is consistent and any sudden change or a discontinuity (e.g., a temporal coherence breakdown) in motion can create errors that propagate in future images that introduce errors into the optical flow.

Such challenges can pose difficulties in accurately estimating pixel motion between sequential images. Errors introduced in optical flow between images can propagate and compound as optical flow is determined in subsequent images, leading to progressively larger inaccuracies in motion estimation. Such compounding errors can be referred to as error accumulation or error propagation. Error accumulation/propagation can lead to poor quality in optical flow performance. For example, when an optical flow algorithm makes an incorrect optical flow estimation at a certain point in a first image, the incorrect optical flow estimation can compound in subsequent images based on previously estimated flow.

Errors introduced in one image can accumulate over time and, as the optical flow algorithm uses the estimated motion vectors from the previous image to initialize or guide the estimation in the current image, any inaccuracies in the initial image will influence the subsequent images. The cumulative effect can result in a significant divergence from the true motion trajectory. An optical flow algorithm may encounter challenges in handling occlusions or outliers. When occlusions are not properly accounted for, the algorithm may assign incorrect velocities to pixels, which results in compounding errors in subsequent images. In addition, optical flow algorithms should also address dynamic changes within the environment, such as sudden object movements, scene transformations, etc. Irrespective of the type of error, any error in optical flow from one image may cascade into the following images and exacerbate inaccuracies in the motion estimation.

In some aspects, systems, apparatuses, processes (also referred to as methods), and computer-readable media (collectively referred to herein as “systems and techniques”) are described for improving disparity information for disparity estimation applications, including optical flow information for optical flow estimation and depth information for stereo depth estimation. For instance, I systems and techniques can reverse warp a current image to generate an estimated previous image, and can compare the estimated previous image with the previous image to identify defective optical flows in the optical flow information. In some aspects, the systems and techniques generate a confidence map that identifies defective optical flows based on the comparison. The confidence map can be applied to the optical flow information to remove (or “clean”) defective optical flows, preventing the introduction of errors into the optical flow information.

In some aspects, the systems and techniques can use different techniques to generate the confidence map, such as based on a dynamic threshold referred to herein as a “validity threshold.” The validity threshold can be used to identify whether optical flow is deemed valid or invalid within optical flow information and can be dynamic based on different criteria. In one illustrative example, progression of an optical flow can increase the validity threshold based on the number of iterations of the optical flow (e.g., with respect to time that the optical flow was initiated). Sparsity of features in captured images can also be used to increase or decrease the validity threshold. In some aspects, the magnitude of the flow can also adjust the validity threshold, and the attention associated with a feature can also adjust the validity threshold. In some aspects, the different types of feature detection techniques can be implemented using machine learning (ML) techniques, such as using one or more neural networks.

The systems and techniques can apply the confidence map to the optical flow information and clean the optical flow to prevent the introduction of errors that compound in subsequent optical flow determinations or predictions. In some cases, the systems and techniques can forward warp images in time based on optical flow information and identify objects that become occluded between two images.

While examples described herein are described herein with respect to optical flow estimation, the systems and techniques can be applied to any disparity estimation application, including stereo depth estimation. For instance, the techniques for optical flow and stereo depth are similar, except that optical flow is for two-dimensional (2D) disparity and (rectified) stereo depth is for one-dimensional (1D) disparity, so inversion and self cleaning are operated in 2D (e.g., in horizontal (x) and vertical (y) directions) for optical flow and in 1D (x-direction only) for stereo depth.

Various aspects and examples of the systems and techniques will be described below with respect to the figures.

In general, image sensors include one or more arrays of photodiodes or other photosensitive elements. Each photodiode measures an amount of light that eventually corresponds to a particular pixel in the image produced by the image sensor. In some cases, different photodiodes may be covered by different color filters of a color filter array and may thus measure light matching the color of the color filter covering the photodiode.

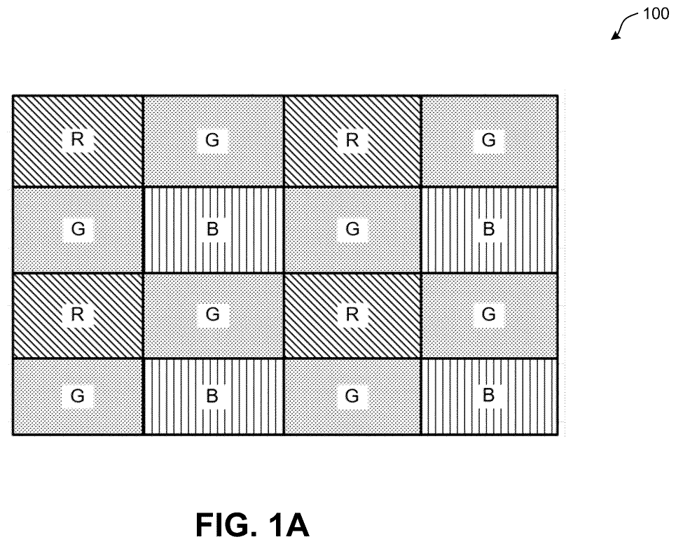

Various color filter arrays can be used, including a Bayer color filter array, a quad color filter array (also referred to as a quad Bayer filter or QCFA), and/or other color filter array. An example of a Bayer color filter array 100 is shown in FIG. 1A. As shown, the Bayer color filter array 100 includes a repeating pattern of red color filters, blue color filters, and green color filters. As shown in FIG. 1B, a QCFA 110 includes a 2×2 (or “quad”) pattern of color filters, including a 2×2 pattern of rI (R) color filters, a pair of 2×2 patterns of green (G) color filters, and a 2×2 pattern of blue (B) color filters. The pattern of the QCFA 110 shown in FIG. 1B is repeated for the entire array of photodiodes of a given image sensor. Using either QCFA 110 or the Bayer color filter array 100, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. The different photodiodes throughout the pixel array can have different spectral sensitivity curves, therefore responding to different wavelengths of light. Monochrome image sensors may also lack color filters and therefore lack color depth.

In some cases, subgroups of multiple adjacent photodiodes (e.g., 2×2 patches of photodiodes when QCFA 110 shown in FIG. 1B is used) can measure the same color of light for approximately the same region of a scene. For example, when photodiodes included in each of the subgroups of photodiodes are in close physical proximity, the light incident on each photodiode of a subgroup can originate from approximately the same location in a scene (e.g., a portion of a leaf on a tree, a small section of sky, etc.).

In some examples, a brightness range of light from a scene may significantly exceed the brightness levels that the image sensor can capture. For example, a digital single-lens reflex (DSLR) camera may be able to capture a 1:30,000 contrast ratio of light from a scene while the brightness levels of an HDR scene can exceed a 1:1,000,000 contrast ratio.

In some cases, HDR sensors may be utilized to enhance the contrast ratio of an image captured by an image capture device. In some examples, HDR sensors may be used to obtain multiple exposures within one image, where such multiple exposures can include short (e.g., 5 ms) and long (e.g., 15 or more ms) exposure times. As used herein, a long exposure time generally refers to any exposure time that is longer than a short exposure time.

In some implementations, HDR sensors may be able to configure individual photodiodes within subgroups of photodiodes (e.g., the four individual R photodiodes, the four individual B photodiodes, and the four individual G photodiodes from each of the two 2×2 G patches in the QCFA 110 shown in FIG. 1B) to have different exposure settings. A collection of photodiodes with matching exposure settings is also referred to as photodiode exposure group herein. FIG. 1C illustrates a portion of an image sensor array with a QCFA filter that is configured with four different photodiode exposure groups 1 through 4. As shown in the example photodiode exposure group array 120 in FIG. 1C, each 2×2 patch can include a photodiode from each of the different photodiode exposure groups for a particular image sensor. Although four groupings are shown in a specific grouping in FIG. 1C, a person of ordinary skill will recognize that different numbers of photodiode exposure groups, different arrangements of photodiode exposure groups within subgroups, and any combination thereof can be used without departing from the scope of the present disclosure.

As noted with respect to FIG. 1C, in some HDR image sensor implementations, exposure settings corresponding to different photodiode exposure groups can include different exposure times (also referred to as exposure lengths), such as short exposure, medium exposure, and long exposure. In some cases, different images of a scene associated with different exposure settings can be formed from the light captured by the photodiodes of each photodiode exposure group. For example, a first image can be formed from the light captured by photodiodes of photodiode exposure group 1, a second image can be formed from the photodiodes of photodiode exposure group 2, a third image can be formed from the light captured by photodiodes of photodiode exposure group 3, and a fourth image can be formed from the light captured by photodiodes of photodiode exposure group 4. Based on the differences in the exposure settings corresponding to each group, the brightness of objects in the scene captured by the image sensor can differ in each image. For example, well-illuminated objects captured by a photodiode with a long exposure setting may appear saturated (e.g., completely white). In some cases, an image processor can select between pixels of the images corresponding to different exposure settings to form a combined image.

In one illustrative example, the first image corresponds to a short exposure time (also referred to as a short exposure image), the second image corresponds to a medium exposure time (also referred to as a medium exposure image), and the third and fourth images correspond to a long exposure time (also referred to as long exposure images). In such an example, pixels of the combined image corresponding to portions of a scene that have low illumination (e.g., portions of a scene that are in a shadow) can be selected from a long exposure image (e.g., the third image or the fourth image). Similarly, pixels of the combined image corresponding to portions of a scene that have high illumination (e.g., portions of a scene that are in direct sunlight) can be selected from a short exposure image (e.g., the first image.

In some cases, an image sensor can also utilize photodiode exposure groups to capture objects in motion without blur. The length of the exposure time of a photodiode group can correspond to the distance that an object in a scene moves during the exposure time. If light from an object in motion is captured by photodiodes corresponding to multiple image pixels during the exposure time, the object in motion can appear to blur across the multiple image pixels (also referred to as motion blur). In some implementations, motion blur can be reduced by configuring one or more photodiode groups with short exposure times. In some implementations, an image capture device (e.g., a camera) can determine local amounts of motion (e.g., motion gradients) within a scene by comparing the locations of objects between two consecutively captured images. For example, motion can be detected in preview images captured by the image capture device to provide a preview function to a user on a display. In some cases, a machine learning model can be trained to detect localized motion between consecutive images.

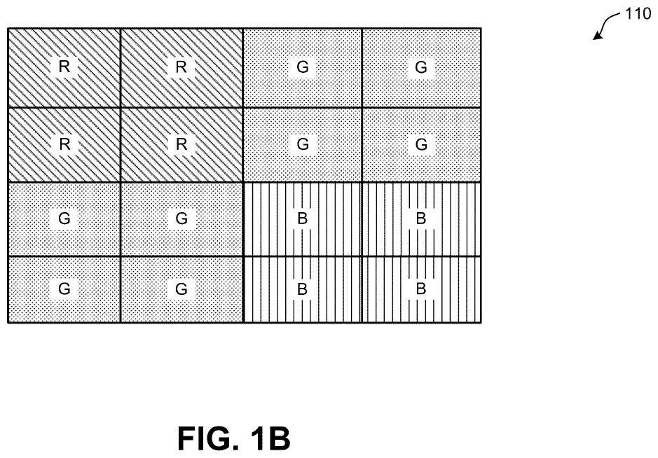

Various aspects of the techniques described herein will be discussed below with respect to the figures. FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms controlling analog gain, flash, HDR, depth of field, and/or other image capture properties.

The focus control mechanism 225B of the control mechanisms 220 can obtain a focus setting. In some examples, focus control mechanism 225B store the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor and focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 230 (e.g., ISO speed or film speed), analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image capture and processing system 200 can include a wide angle image sensor with a relatively low zoom and a telephoto image sensor with a greater zoom. In some cases, based on the selected zoom setting, the zoom control mechanism 225C can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array (as shown in FIG. 1A), a QCFA (see FIG. 1B), and/or any other color filter array.

Returning to FIG. 1A and FIG. 1B, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, low-pass filter, high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

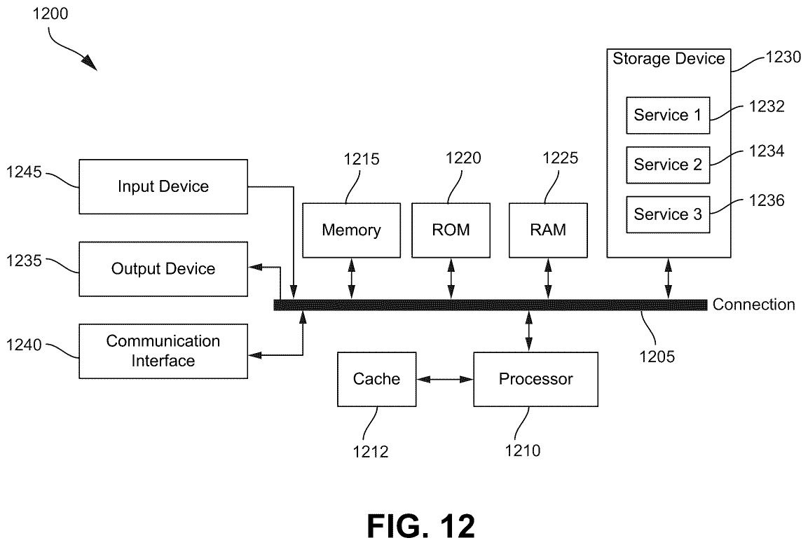

The image processor 250 may include one or more processors, such as one or more ISPs (e.g., ISP 254), one or more host processors (e.g., host processor 252), and/or one or more of any other type of processor 1110 discussed with respect to the computing system 1200 of FIG. 12. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various I/O devices 260 may be connected to the image processor 250. The I/O devices 260 can include a display screen, a keyboard, a keypad, a touchscreen, a trackpad, a touch-sensitive surface, a printer, any other output devices 1135, any other input devices 1145, or some combination thereof. In some cases, a caption may be input into the image processing device 205B through a physical keyboard or keypad of the I/O devices 260, or through a virtual keyboard or keypad of a touchscreen of the I/O devices 260. The I/O devices 260 may include one or more ports, jacks, or other connectors that enable a wired connection between the image capture and processing system 200 and one or more peripheral devices, over which the image capture and processing system 200 may receive data from the one or more peripheral device and/or transmit data to the one or more peripheral devices. The I/O devices 260 may include one or more wireless transceivers that enable a wireless connection between the image capture and processing system 200 and one or more peripheral devices, over which the image capture and processing system 200 may receive data from the one or more peripheral device and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O devices 260. In some cases, certain components illustrated in the image capture device 205A, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

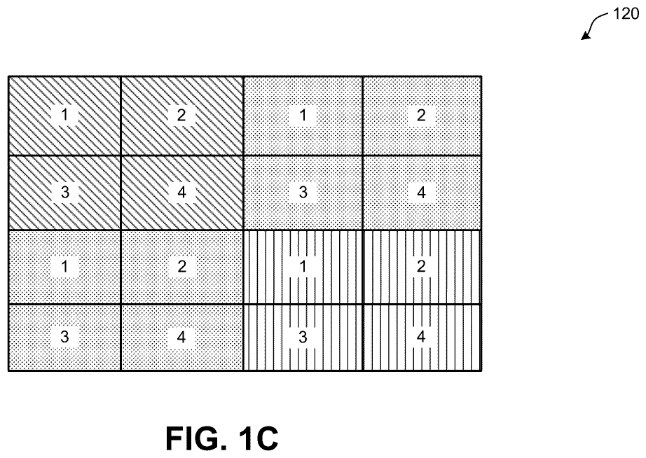

FIG. 3 is a block diagram illustrating an example of an image capture system 300. The image capture system 300 includes various components that are used to process input images or frames to produce disparity information, such as optical flow information, stereo depth (or disparity) information, or other type of disparity information. As shown, the components of the image capture system 300 include one or more image capture devices 302, an disparity engine 310, and disparity information consumers 312. The image capture device 302 can produce an image of a scene and the disparity information consumers 312 can analyze the image and previous image to generate disparity information, such as an optical flow, depth information, and/or other type of disparity information, as described in more detail herein. In some aspects, the disparity information consumers 312 can use reverse warping to build a confidence map and identify authentic flows and defective flows. In some aspects, the disparity engine 310 may also provide depth information. For example, the disparity engine 310 may be configured to perform stereo depth estimation between a pair of images to determine disparity, and may determine the depth information from the disparity.

The image capture system 300 can include or be part of an electronic device or system. For example, the image capture system 300 can include or be part of an electronic device or system, such as a mobile or stationary telephone handset (e.g., smartphone, cellular telephone, or the like), an extended reality (XR) device (e.g., a virtual reality (VR) device, an augmented reality (AR) device, or a mixed reality (MR) device), a vehicle or computing device/system of a vehicle, a drone system, an autonomous robot, a server computer (e.g., in communication with another device or system, such as a mobile device, an XR system/device, a vehicle computing system/device, etc.), a desktop computer, a laptop or notebook computer, a tablet computer, a set-top box, a television, a camera device, a display device, a digital media player, a video streaming device, or any other suitable electronic device. In some examples, the image capture system 300 can include one or more wireless transceivers (or separate wireless receivers and transmitters) for wireless communications, such as cellular network communications, 802.11 Wi-Fi communications, WLAN communications, Bluetooth or other short-range communications, any combination thereof, and/or other communications. In some implementations, the components of the image capture system 300 can be part of the same computing device. In some implementations, the components of the image capture system 300 can be part of two or more separate computing devices.

While the image capture system 300 is shown to include certain components, one of ordinary skill will appreciate that image capture system 300 can include more components or fewer components than those shown in FIG. 3. In some cases, additional components of the image capture system 300 can include software, hardware, or one or more combinations of software and hardware. For example, in some cases, the image capture system 300 can include one or more other sensors (e.g., one or more inertial measurement units (IMUs), radars, light detection and ranging (LIDAR) sensors, audio sensors, etc.), one or more display devices, one or more other processing engines, one or more other hardware components, and/or one or more other software and/or hardware components that are not shown in FIG. 3. In some implementations, additional components of the image capture system 300 can include and/or can be implemented using electronic circuits or other electronic hardware, which can include one or more programmable electronic circuits (e.g., DSPs, microprocessors, microcontrollers, GPUs, CPUs, any combination thereof, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture system 300.

The image capture device 302 can capture image data and generate images (or frames) based on the image data and/or can provide the image data to the disparity engine 310 to generate disparity information. For example, the disparity engine 310 can determine optical flow information based on optical flow motion estimation techniques for various purposes. The optical flow motion estimation can be performed on a pixel-by-pixel basis. For instance, for each pixel in the image y, the motion estimation f defines the location of the corresponding pixel in the image x. The motion estimation f for each pixel can include a vector (e.g., a motion vector) indicating a movement of the pixel between the images. In some cases, optical flow maps (e.g., also referred to as motion vector maps) can be generated based on the computation of the optical flow vectors between images. The optical flow maps can include an optical flow vector for each pixel in an image, where each vector indicates a movement of a pixel between the images. In one illustrative example, the optical flow vector for a pixel can be a displacement vector (e.g., indicating horizontal and vertical displacements, such as x- and y-displacements) showing the movement of a pixel from a first image to a second image. In some aspects, the optical flow estimation techniques can also include depth estimation techniques (e.g., stereo depth estimation).

In some cases, the optical flow map can include vectors for less than all pixels in an image. For instance, a dense optical flow can be computed between images to generate optical flow vectors for each pixel in at least one of the images, which can be included in a dense optical flow map. In some examples, each optical flow map can include a 2D vector field, with each vector being a displacement vector showing the movement of points from a first image to a second image.

As noted above, an optical flow vector or optical flow map can be computed between images of a sequence of images. Two images can include two directly adjacent images that are consecutively captured images or two images that are a certain distance apart (e.g., within two images of one another, within three images of one another, or any other suitable distance) in a sequence of images. In one illustrative example, a pixel I (x, y, t) in the image x can move by a distance or displacement (Δx, Δy) in the image y.

The disparity information (e.g., optical flow information, depth information, etc.) is provided to disparity information consumers 312 for various purposes. For example, the disparity information consumer 312 may be a control system of an autonomous navigation system for navigating an autonomous vehicle within the physical world. In the example of an autonomous navigation system, optical flow information can be used to identify objects within the environment, such as a person crossing the road, or identify movement of a fixed object to ascertain displacement information pertaining to how the autonomous vehicle is moving. The disparity information consumer 312 can also be a security system and is configured to identify movement of a person to trigger recording or bring the movement to the attention of a supervising person or other supervising control system.

In some aspects, the disparity engine 310 may include reverse error correction (e.g., reverse optical flow error correction, reverse depth error correction, etc.) to correct errors detected between two sequential images. In one aspect, the disparity engine 310 is configured to generate optical flow information between a previous image and a current image. The disparity engine 310 inversely warps the current image based on optical flow information to generate an estimated previous image. The disparity engine 310 compares the estimated previous image to the previous image to identify defective optical flows and may clean the optical flow information based on the defective optical flows. In some aspects, cleaning the defective optical flows prevents the introduction of defects that can promulgate into later optical flows and create errors that cascade over time. For example, cleaning the defective optical flow may remove various defects that can be introduced between subsequent images (e.g., temporal coherence breakdown, local inconsistencies, etc. as described above).

As described herein, in some aspects, the systems and techniques can also be used in disparity estimation applications other than for optical flow estimation, such and stereo depth estimation. Stereo depth information can be corrected using similar techniques based on a one-dimensional disparity between two cameras used to capture two images, referred to as a current frame pair. The systems and techniques can generate depth information from the current frame pair, inverse warp the current frame pair based on the depth information and identify defective depth information. In some aspects, techniques for correcting the depth information is similar to the techniques described herein for correcting optical flow information, except that optical flow is for two-dimensional disparity and stereo depth is for one-dimensional disparity. In such aspects, the inversion and self cleaning operations described herein are operated in 2D (e.g., in horizontal (x) and vertical (y) directions) for optical flow and in 1D (x-direction only) for stereo depth.

The one or more image capture devices 302 can also provide the image data to an output device for output (e.g., on a display). In some cases, the output device can also include storage. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image. In addition to image data, the image capture devices can also generate supplemental information such as the amount of time between successively captured images, timestamps of image capture, or the like.

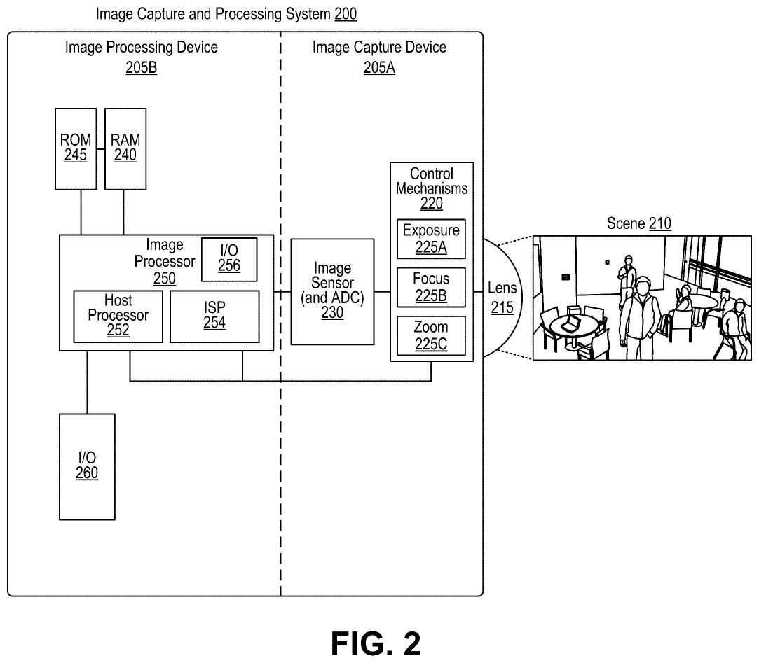

FIG. 4 is a conceptual diagram of an optical flow correction system 400 that provides reverse optical flow error correction in accordance with some aspects of the disclosure. The techniques described with respect to FIG. 4 may also be used for other disparity estimation techniques, such as for stereo depth estimation. The optical flow correction system 400 includes an optical flow engine 402 (e.g., included in the disparity engine 310), a reverse warping engine 404, and a correction engine 406.

At time to, the optical flow engine 402 is configured to receive a first image 410 (or frame). The optical flow engine 402 is configured to extract a plurality of features from the first image 410 to generate a feature map F_{1,0}. The reverse warping engine 404 is not configured to receive any information because image 410 is a first image related to a new optical flow. For example, the optical flow correction system 400 can detect an environment change that causes the optical flow engine 402 to discard previous data. A non-limiting example of a scene change can include a change in average luminance that affects previous optical flows, such as an autonomous vehicle entering a tunnel.

At time t₁, the optical flow engine 402 receives a second image 420 and feature map F_{1,0} from the first image 410. The optical flow engine 402 extracts features from the second image 420, generates feature map F_{2,0}, and then generates optical flow information \hat{f}_{12,i} corresponding to motion between the feature map F_{2,0} and the feature map F_{2,0}. In one aspect, the optical flow engine 402 is configured to use an iterative process to estimate a dense flow field in iteration i for the pixelwise displacement of features between the feature laps F_{1,i} and F_{2,i}.

In one aspect, the reverse warping engine 404 is configured to warp the feature map F_{2,0} based on the optical flow information \hat{f}_{12,i}. For example, the reverse warping engine 404 is configured to reverse warp the feature map F_{2,0} to generate an estimated first feature map F′_{2,i}. The estimated first feature map F′_{2,i} is based on a warping function W (F_{2,i}, \hat{f}_{12,i}), with W corresponding to

The reverse warping engine 404 generates warped optical flow information F′_{2,1}=W(F_{2,i}, \hat{f}_{12,i}), with W corresponding to a reverse warping operation in time that takes a feature map F_{2,i} and the corresponding optical flow information \hat{f}_{12,i} to produce a feature map output F′_{2,1}. For example, the reverting the pixelwise displacements of F_{2,i} according to flow field \hat{f}_{12,i} for each output pixel p_{x,y} of F_{1,i} by associating with and interpolating the queried coordinates in F_{2,i}.

In some aspects, the warped optical flow information F′_{2,i} and the feature map F_{1,0} are provided to the correction engine 406 for reverse optical flow error correction. The correction engine 406 is configured to determine a difference between the feature map F_{1,0} and warped optical flow information F′_{2,1}. In one aspect, the correction engine 406 may apply a negation of the difference above to a Gaussian kernel function, as illustrated in Equation 1 below, or any other suitably defined function by design.

$$G ( {F}_{1} , {F}_{2}^{′} , ) {=}^{Δ} exp ( \frac{- 1}{2 \sqrt{d}} {‖ {F}_{1 , ( x , y )} - {F}_{2 , ( x , y )}^{′} ‖}_{2}^{2} ) = exp ( \frac{- 1}{2 \sqrt{d}} {\sum }_{C} {( {F}_{1 , ( x , y )} - {F}_{2 , ( x , y )}^{′} )}^{2} ) \qquad ( Eq . 1 )$$

In Equation 1, C corresponds to the set of elements in the channel dimension for the corresponding coordinate (x,y) of the feature maps F₁ and F′₂. The Gaussian kernel includes a property for its value range as defined in Equation 2.

$${0 \leq G ( {F}_{1} , {F}_{2}^{′} , ) \vert}_{( x , y )} \leq 1 \qquad ( Eq . 2 )$$

The maximum of the value range of the Gaussian kernel corresponds to ∥F_{1,(x,y)}−F_{2,(x,y)}∥₂²=0 and the minimum corresponds to ∥F_{1,(x,y)}−F_{2,(x,y)}∥₂²=∞. The correction engine 406 is further configured to build a confidence map to determine a validity (e.g., whether an optical flow is defective) based on the Gaussian kernel. In one aspect, a validity threshold (e.g., represented as a scaler T) and the feature map F (F₁, F′₂) from the Gaussian Kernel function apply the function in Equation 3 to generate a confidence map.

$${V \vert}_{T ( x , y )} = \{ \begin{matrix}1 , {G ( {F}_{1} , {F}_{2}^{′} )}_{( x , y )} \geq T \\ 0 , {G ( {F}_{1} , {F}_{2}^{′} )}_{( x , y )} lt ; T\end{matrix} \qquad ( Eq . 3 )$$

The confidence map V (or the validity map) to adjust the estimated flow \hat{f}_{12,i} for iteration i with \hat{f}_{12,i}=V·\hat{f}_{12,i} and the “·” operator is the Hadamard multiplication. In some aspects, the confidence map V corresponds to the confidence of the optical flow between the various features in the first image 410 and the second image 420 (and in some cases between the first image 410 and a third image 430 and/or between the second image 420 and the third image 430). For example, if there are no optical flow errors, the features from the estimated first image should strongly correspond to the first image. In some aspects, different thresholding functions can be configured to improve the detection of defective optical flows. For example, the validity threshold can be based on an iteration associated with the optical flow (e.g., later optical flow having a higher threshold), a density of features proximate to the feature (e.g., sparsity), based on the magnitude of the optical flow (e.g., flow guide), semantic thresholding (e.g., using an attention module), and occlusion detection.

In some aspects, the optical flow correction system 400 is configured to provide reverse optical flow error correction. For example, the optical flow correction system 400 identifies defective flows based on reverse warping a current image with respect to time and prevents the introduction of the defective flows to reduce errors. The optical flow correction system 400 compares the reverse warped image to a ground truth to determine the confidence of the optical flow between a previous image and a current image and, which can preclude the introduction of defective flows. Although FIG. 4 illustrates that the reverse warping engine 404 receives the feature information, the reverse warping engine 404 may also use a bitmap image to build the confidence map and then clean the optical flow information.

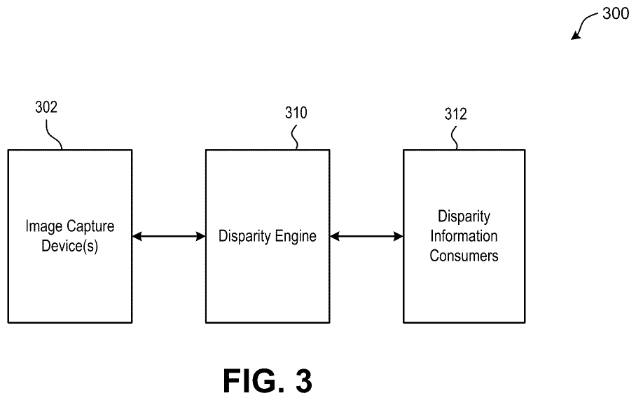

FIG. 5 is a block diagram of an optical flow correction system 500 configured to perform reverse optical flow error correction in accordance with some aspects of the disclosure. In some aspects, the optical flow correction system 500 includes an encoder 510, an optical flow engine 520, a warping engine 530, a confidence engine 540, and a correction engine 550. An image 502 is received by the encoder 510, which is configured to identify features in each image. The features are often referred to as vectors or tokens and refer to the transformed representation of input data generated by the encoding process. The encoder 510 extracts relevant features from the input data (e.g., image 502) and converts the features into a condensed and meaningful format. The features encapsulate essential information, patterns, and characteristics inherent in the input data (e.g., image 502) and are a distilled representation that is more amenable to analysis by downstream components of the optical flow correction system 500.

In one aspect, the encoder 510 transforms and processes information, particularly in the context of artificial intelligence and machine learning. The encoder 510 is configured to convert raw input data (e.g., an image 502) into a structured format that is conducive to analysis and pattern recognition. For example, the encoder 510 can include or be part of a machine learning system (e.g., a deep neural network (DNN), a convolutional neural network (DNN), a transformer neural network, a diffusion neural network, any combination thereof, and/or other type of machine learning system). In such an example, the encoder 510 can process the image 502 to generate features representing the image 502. In some cases, the features are multidimensional vectors or tokens. In some aspects, the features of the image 502 can be used by various other engines for various purposes. For example, the features may be used by the optical flow engine 520 to identify the motion of a feature between images, or an attention engine (not shown) that is configured to identify the importance of the feature as compared to other features within the image.

The optical flow engine 520 is configured to generate optical flow information based on detected motion between two images. The warping engine 530 is configured to warp the image 502 based on optical flow information from the optical flow engine 520. For example, the warping engine 530 is configured to reverse warp the image 502 in time and generate an estimated previous image. In some cases, the optical flow engine 520 may perform different warping operations. For example, the optical flow engine 520 may forward warp a previous image into an estimated current image and compare the estimated current image and the current image. In some aspects, combining the forward warped image and the reverse warped image can be used to detect the occlusion of objects.

The confidence engine 540 is configured to receive the images (e.g., a previous image, a current image, an estimated previous image, and an estimated current image) and optical flow information from the optical flow engine 520 and the warping engine 530. In some aspects, the confidence engine 540 is configured to generate confidence information based on the optical flow information and various images. In some aspects, the confidence engine 540 can use one or more engines to dynamically build the confidence information. For example, the confidence engine 540 may include a progression engine 541, a sparsity engine 542, a flow-guided engine 543, a semantic engine 544, and an occlusion detection engine 545.

Each of the progression engine 541, the sparsity engine 542, the flow-guided engine 543, and the semantic engine 544 are configured to dynamically adjust a validity threshold that is associated with the confidence of an optical flow with respect to detected features. The validity threshold identifies whether the optical flow is deemed valid or invalid. For example, a difference between an estimated image (e.g., the estimated previous image) and an estimated image is a confidence (e.g., a likelihood) that the feature in the estimated previous image is the same feature in the previous image. The confidence engine 540 uses the validity threshold to generate a mask that identifies valid optical flow and invalid optical flows and provides the mask to the correction engine 550. The mask can be a two-dimensional bitmap, multi-dimensional vectors, or matrices that can be applied to the optical flow information.

In one aspect, the progression engine 541 dynamically adjusts the validity threshold of the confidence engine 540 based on the iteration (or progression) of the confidence engine with respect to the initial state of a current environment. An initial state corresponds to when a control state is reset based on feedback. For example, time t₀ of FIG. 4 illustrates an initial state that is caused by a change within the optical flow correction system 500 that prevents feedback of optical information into time t₀. Non-limiting examples of events that cause feedback include abrupt changes in luminance (e.g., entering a tunnel while driving), abrupt changes in background content (e.g., turning an autonomous vehicle), and so forth. The progression engine 541 is configured to increase the validity threshold based on the number of iterations to prevent the introduction of errors in longer iterations. For example, when an autonomous vehicle drives on a long stretch of road, the environment does not significantly change, and the validity threshold increases for introducing new features and errors into the optical flow. However, when an autonomous vehicle turns or experiences an abrupt change, the optical flow correction system 500 reduces the validity threshold to ensure that new features and environmental features that are useful are introduced into the optical flow. In some aspects, the progression engine 541 may increase the validity threshold to disable self-cleaning by the optical flow correction system 500.

The sparsity engine 542 dynamically adjusts the validity threshold of the confidence engine 540 based on the sparsity of features within the current environment and/or optical flow. For example, the sparsity engine 542 may adjust the validity threshold based on the sparsity of neighboring features (e.g., neighboring pixels). For example, in a region where the validity is sparse (e.g., V_{(x,y)}=0 for a majority of pixels in this region), the sparsity engine 542 may apply a more conservative validity threshold in this region.

The flow-guided engine 543 dynamically adjusts the validity threshold of the confidence engine 540 based on the optical flow. The flow-guided engine 543 may dynamically adjust the validity threshold for a pixel based on the amplitude of the flow (e.g., \hat{f}_{12,i}) at that pixel. For example, when the flow amplitude of a pixel is smaller, the flow-guided engine 543 may increase the validity threshold because incorrectly detecting smaller motion is relatively safer, and correcting the optical flow in later flows is simpler than larger motion.

The semantic engine 544 dynamically adjusts the validity threshold of the confidence engine 540 based on the feature, the scene, or certain semantic attributes of that region or pixel. The semantic engine 544 may include an attention module that is configured to determine an attention within the scene between two images. For example, the semantic engine 544 can use the attention module to distinguish between background content and foreground content to identify features to track. Based on the attention associated with the features, the semantic engine 544 can dynamically adjust the validity threshold. For example, features that have less attention (e.g., deemed less important) can have a higher validity threshold, and features that have more attention can have a lower validity threshold.

The confidence engine 540 can also include an occlusion detection engine 545 for detecting objects entering or leaving an occlusion state. In one aspect the occlusion detection engine 545 may estimate two optical flows of both directions (e.g., forward flow and backward flow), and then perform warping in both the forward and backward directions. For example, with two encoded feature maps F₁ and F₂ from the input image pair, the occlusion detection engine 545 estimates both flows, \hat{f}₁₂ and \hat{f}₂₁, and applies cyclic warping in both directions in a image pair. Cyclic warping generates two estimated optical flows F₁′=W (F₁, \hat{f}₂₁) and F₁″=W(F₁, \hat{f}₁₂) The estimated optical flows can be used to identify if an object is occluded.

In some aspects, the confidence engine 540 can also include one or more ML models (not shown) configured to execute a combination of detection engines. For example, the one or more ML models can be trained based on a combination of techniques to vary the validity threshold of the confidence engine 540 based on progression (e.g., the progression engine 541), sparsity (e.g., the sparsity engine 542), flow magnitude (e.g., the flow-guided engine 543), and attention (e.g., the semantic engine 544).

The correction engine 550 receives the estimated optical flow from the confidence engine 540 and cleans and outputs from the optical flow information 560 from the optical flow correction system 500. By cleaning the invalid flows from the optical flow information, the correction engine 550 prevents the introduction of errors based on the analysis performed in the confidence engine 540 and increases the accuracy and the quality of the optical flow information of the optical flow correction system 500.

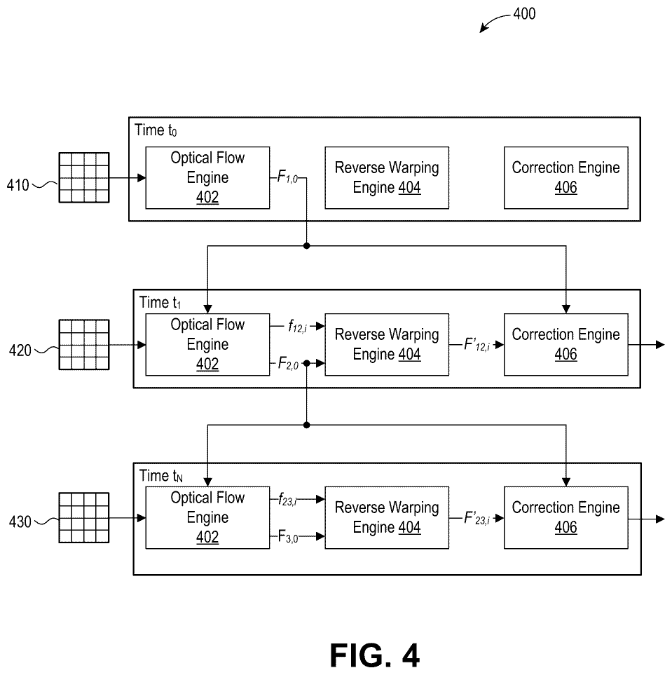

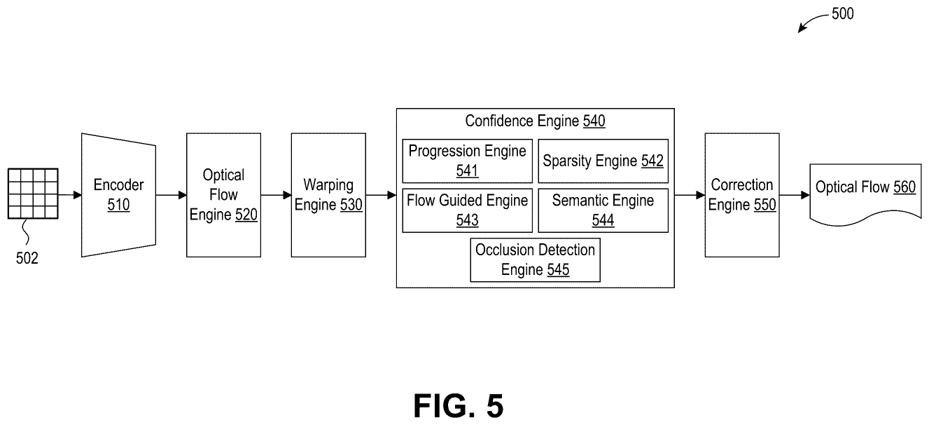

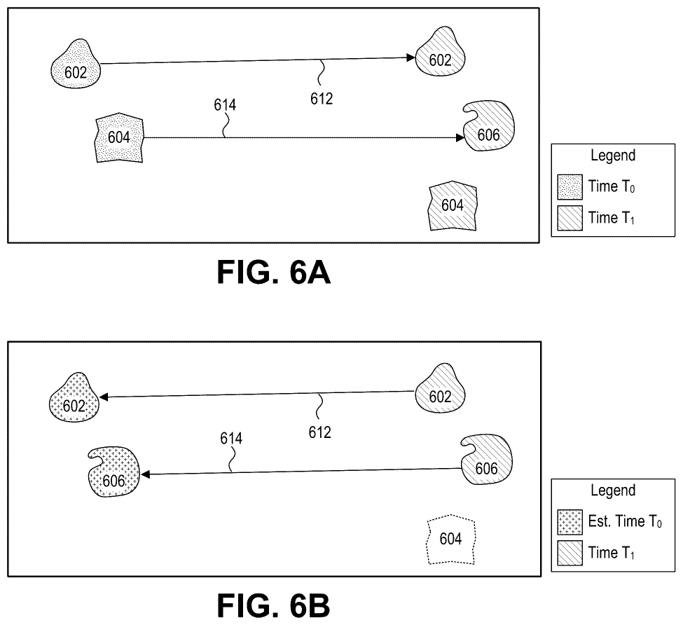

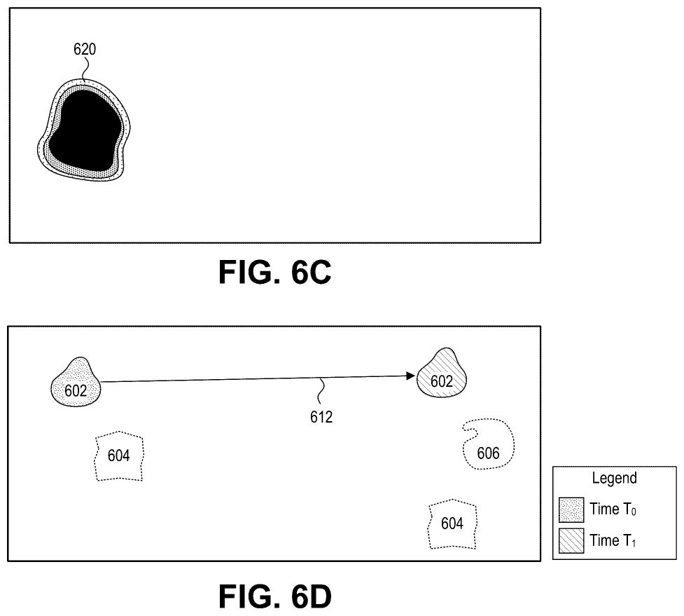

FIG. 6A is a conceptual illustration of an optical flow between two images and an error that can be introduced in accordance with some aspects of the disclosure. In some aspects, FIG. 6A illustrates a first feature 602 and a second feature 604 that are present at time to and move across the image at time t₁. As noted by the legend, the fill pattern corresponds to the position of the first feature 602 and the second feature 604. The first feature 602 moves based on a first optical flow 612. However, a second optical flow 614 associated with the second feature 604 is incorrect and identifies a third object 606. The third object 606 may be present at time t₀ and is omitted to simplify the illustration. The error illustrated by the second optical flow 614 can compound in subsequent images and reduce the quality of object detection and tracking.

FIG. 6B is a conceptual illustration of an estimated previous image and identification of an error in accordance with some aspects of the disclosure. In some aspects, as described above, the imaging system can perform reverse optical flow error correction by reverse warping the image at time t₁ based on the first optical flow 612 and the second optical flow 614 to generate an estimated image corresponding to time t₀. For example, for each flow information of the image at time t₁, the movement of each feature corresponding is reverse warped. In this case, the second feature 604 may be removed from the estimated image because a flow may not be associated with the second feature 604 at time t₁. A flow can be associated with the second feature 604 at time t₁ and would be incorrect and is omitted for simplicity of explanation.

FIG. 6C is a conceptual illustration of a confidence map that can be used by a cleaning engine to remove an error introduced in optical flow in accordance with some aspects of the disclosure. The image capture system compares the previous image (e.g., at time t₀ in FIG. 6A) with the estimated optical flow (e.g., as shown in FIG. 6B) to generate the confidence map in FIG. 6C. In this example, the third object 606 in the image at time t₁ does not correspond to the object second feature 604 in the image at time to and the confidence map includes a region 620 that indicates a defective flow in the initial optical information. The density of fill patterns in the confidence map indicates the likelihood of an error introduced into the original optical flow information before correction. As described above, the confidence map can be further modified based on the various engines and ML models to improve the detection based on additional criteria (e.g., progression by the progression engine 541, sparsity by the sparsity engine 542, flow magnitude by the flow-guided engine 543, etc.).

FIG. 6D is a conceptual illustration of a cleaned optical flow in accordance with some aspects of the disclosure. In some aspects, the confidence map is provided to a correction engine (e.g., the correction engine 550 of FIG. 5, the correction engine 406 of FIG. 4) to clean the optical flow information of defective flows. In this case, the first optical flow 612 of the first feature 602 is preserved and the optical flow associated with the second feature 604 and the third object 606 is removed (e.g., the second optical flow 614).

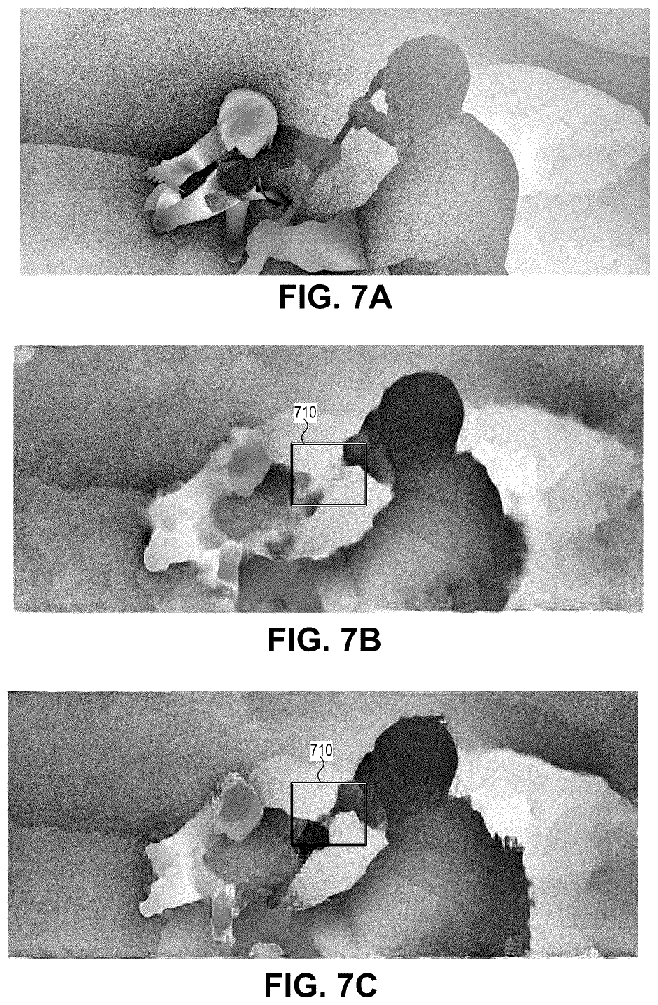

FIGS. 7A-7C are illustrations of examples of optical flow without a ground truth, optical flow without reverse optical flow error correction, and optical flow with reverse optical flow error correction in accordance with some aspects of the disclosure.

In particular, FIG. 7A illustrates a ground truth of an optical flow between two consecutive images. FIG. 7B illustrates an optical flow of two consecutive images using an optical flow engine (e.g., the optical flow engine 520 of FIG. 5) without any reverse optical flow error correction. As shown in FIG. 7B, a region 710 is missing flow information that is present in FIG. 7A and corresponds to at least one region of the optical flow information including defective optical flows. FIG. 7C illustrates the same optical flow of the two consecutive images using the same optical flow engine, but with additional reverse optical flow error correction (e.g., using the optical flow correction system 500 of FIG. 5). In FIG. 7C, the region 710 includes flow information that is missing in FIG. 7B. In this case, the reverse optical flow error correction prevents the introduction of errors that can cascade and compound downstream in the optical information.

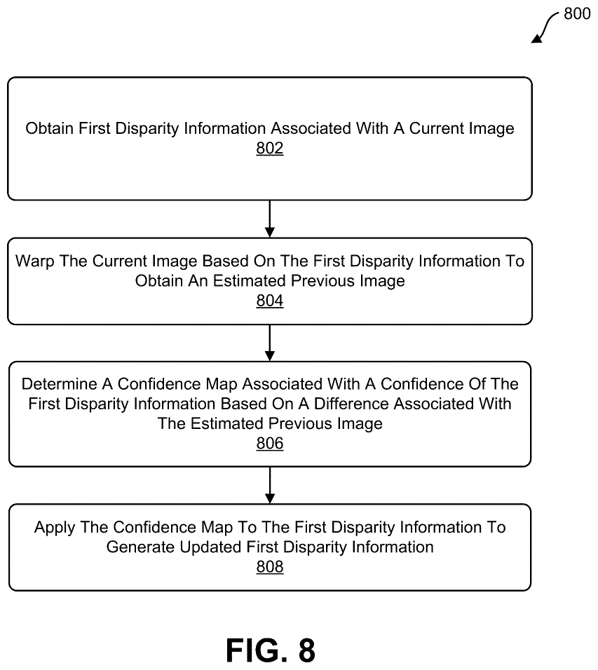

FIG. 8 is a flowchart illustrating an example process 800 for capturing images using an image capture system and estimating optical flow information in accordance with aspects of the present disclosure. The process 800 can be performed by a computing device (e.g., including image sensor) or a component or system (e.g., a chipset, one or more processors, one or more machine learning models such as one or more neural networks, any combination thereof, and/or other component or system) of the computing device. In some examples, the computing device can include a mobile wireless communication device, a vehicle (e.g., an autonomous or semi-autonomous vehicle, a wireless-enabled vehicle, and/or other type of vehicle) or computing device or system of the vehicle, a robot device or system (e.g., manufacturing), a camera, an XR device, or another computing device. In one illustrative example, a computing system (e.g., computing system 1100) can be configured to perform all or part of the process 800. In one illustrative example, the optical flow correction system 400 and/or the optical flow correction system 500 can be configured to perform all or part of the process 800. For instance, the computing system 1100 may include the components of the system 400 and/or 500 and can be configured to perform all or part of the process 800. In another illustrative example, an ISP such as the ISP 254 can be configured to perform all or part of the process 800.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

At block 802, a computing system (e.g., the computing system 1100) may obtain first disparity information associated with a current image. In one aspect, the first disparity information may include first optical flow information estimating a first movement of a first feature to a first destination location in the current image. In another aspect, the first disparity information may include depth information representing a depth of the first feature. For instance, in such an aspect, the computing system may include two or more image capture devices for stereo depth estimation. For example, the computing device may use two image sensors for determining a distance to the first feature from the two image sensors (e.g., stereo depth information). In some aspects, the computing system includes one or more image capture devices.

At block 804, the computing system may warp the current image based on the first disparity information to obtain an estimated previous image.

At block 806, the computing system may determine a confidence map associated with a confidence of the first disparity information based on a difference associated with the estimated previous image (e.g., the difference between a previous image and the estimated previous image). In one aspect, the computing system may determine the difference between a previous image and the estimated previous image. The confidence map comprises a first region corresponding to the first feature that is valid in the first disparity information. The confidence map comprises a different region corresponding to the different feature that is a false positive (e.g., defective flow information) in the first disparity information.

In some cases, the confidence map is determined based on a first threshold at a first time, and the confidence map is determined based on a second threshold at a second time after the first time. The second threshold comprises a higher confidence than the first threshold. For example, the second threshold increases with respect to an iteration of the optic34spects.

In some aspects, the computing system may determine the confidence map based on different criteria. The confidence can be based on the sparsity of features near the first feature, flow magnitude, an attention, and so forth. In one aspect, the computing system can, to determine the confidence map at block 806, determine a sparsity of a region associated with the first feature in the current image or a previous image and determine, based on the sparsity, a threshold corresponding to a confidence of the first feature in the first disparity information.

In one aspect, the computing system can, to determine the confidence map at block 806, determine a first movement magnitude associated with the first feature in the current image. Based on the first movement magnitude, the computing system may determine a first threshold corresponding to a confidence of the first feature within the first disparity information. The threshold may be higher for smaller movements. The computing system may determine, based on the first threshold, whether a region in the confidence map associated with the first feature corresponds to an authentic disparity information.

In one aspect, the computing system can, to determine the confidence map at block 806, determine an attention associated with the first feature. The attention corresponds to an importance of the first feature in association with at least one other feature in the first disparity information. The computing system may determine a first threshold corresponding to an authentication of the first disparity information of the first feature based on the attention. In some aspect, the attention comprises information identifying the importance of the first feature within a previous image and the current image as compared to other features within the previous image and the current image.

In one aspect, the computing system can, to determine the confidence map at block 806, may use a combination of the describe techniques. In some aspects, an ML model can be configured to determine the threshold based on a combination of iteration, flow magnitude, attention, and so forth.

At block 808, the computing system may apply the confidence map to the first disparity information to generate updated first disparity information. The computing system may apply the confidence map to the first disparity information to remove the first disparity information (e.g., defective disparity information) and generate the updated first disparity information.

In some aspect, the computing system may use the first disparity information to identify occluded objects. The computing system may obtain a second disparity information associated with a previous image. In some aspect, the second disparity information estimates a second movement of the first feature within the current image or the previous image or estimate a depth of the first feature. The computing system may warp the previous image based on the second disparity information to obtain an estimated current image and generate a second confidence map associated with the second disparity information based on a difference associated the estimated current image. The computing system may apply the second confidence map to the second disparity information to generate updated second disparity information. The computing system may determine that the first feature is occluded in the current image or the previous image based on the updated first disparity information and the second disparity information.

In some examples, the processes described herein (e.g., process 800, and/or other process described herein) may be performed by a computing device or apparatus. In one example, the process 800 can be performed by a computing device (e.g., image capture and processing system 200 in FIG. 2) having a computing architecture of the computing system 1200 shown in FIG. 12.

The process 800 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the methods.

The process 800, and/or other method or process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

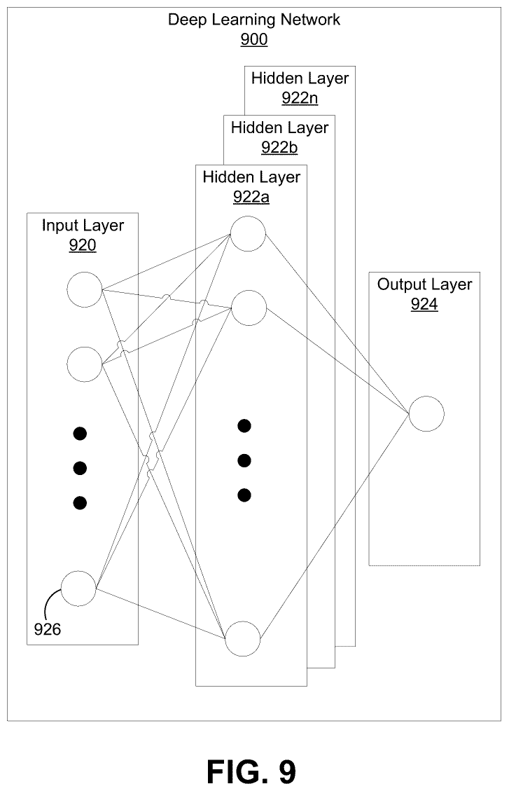

As noted above, various aspects of the present disclosure can use machine learning models or systems. FIG. 9 is an illustrative example of a deep learning neural network 900 that can be used to implement the machine learning-based alignment prediction described above. An input layer 920 includes input data. In one illustrative example, the input layer 920 can include data representing the pixels of an input video frame. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 924 that provides an output resulting from the processing performed by the hidden layers 922a, 922b, through 922n. In one illustrative example, the output layer 924 can provide a classification for an object in an input video frame. The classification can include a class identifying the type of activity (e.g., looking up, looking down, closing eyes, yawning, etc.).

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 924, at which an output is provided. In some cases, while nodes (e.g., node 926) in the neural network 900 are shown as having multiple output lines, a node has a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 924. In an example in which the neural network 900 is used to identify features and/or objects in images, the neural network 900 can be trained using training data that includes both images and labels, as described above. For instance, training images can be input into the network, with each training frame having a label indicating the features in the images (for a feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 900 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 900 is trained well enough so that the weights of the layers are accurately tuned.

For the example of identifying features and/or objects in images, the forward pass can include passing a training image through the neural network 900. The weights are initially randomized before the neural network 900 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 900, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 900 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 900 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 900 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 900 can include any other deep network other than a CNN, such as an autoencoder, a deep belief nets (DBNs), a Recurrent Neural Networks (RNNs), among others.

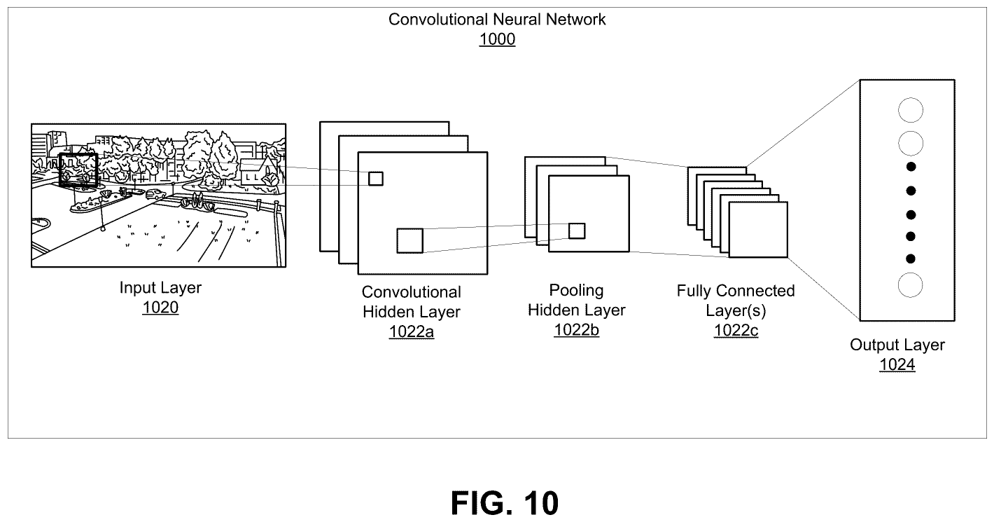

FIG. 10 is an illustrative example of a CNN 1000. The input layer 1020 of the CNN 1000 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1022a, an optional non-linear activation layer, a pooling hidden layer 1022b, and fully connected hidden layers 1022c to get an output at the output layer 1024. While only one of each hidden layer is shown in FIG. 10, one of ordinary skill will appreciate that multiple convolutional hidden layers, non-linear layers, pooling hidden layers, and/or fully connected layers can be included in the CNN 1000. As previously described, the output can indicate a single class of an object or can include a probability of classes that best describe the object in the image.

The first layer of the CNN 1000 is the convolutional hidden layer 1022a. The convolutional hidden layer 1022a analyzes the image data of the input layer 1020. Each node of the convolutional hidden layer 1022a is connected to a region of nodes (pixels) of the input image called a receptive field. The convolutional hidden layer 1022a can be considered as one or more filters (each filter corresponding to a different activation or feature map), with each convolutional iteration of a filter being a node or neuron of the convolutional hidden layer 1022a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1022a. Each connection between a node and a receptive field for that node learns a weight and, in some cases, an overall bias such that each node learns to analyze its particular local receptive field in the input image. Each node of the hidden layer 1022a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1022a is due to each node of the convolutional layer being applied to its corresponding receptive field. For example, a filter of the convolutional hidden layer 1022a can begin in the top-left corner of the input image array and can convolve around the input image. As noted above, each convolutional iteration of the filter can be considered a node or neuron of the convolutional hidden layer 1022a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1022a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1022a.

The mapping from the input layer to the convolutional hidden layer 1022a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1022a can include several activation maps in order to identify multiple features in an image. The example shown in FIG. 10 includes three activation maps. Using three activation maps, the convolutional hidden layer 1022a can detect three different kinds of features, with each feature being detectable across the entire image.

In some examples, a non-linear hidden layer can be applied after the convolutional hidden layer 1022a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 1000 without affecting the receptive fields of the convolutional hidden layer 1022a.

The pooling hidden layer 1022b can be applied after the convolutional hidden layer 1022a (and after the non-linear hidden layer when used). The pooling hidden layer 1022b is used to simplify the information in the output from the convolutional hidden layer 1022a. For example, the pooling hidden layer 1022b can take each activation map output from the convolutional hidden layer 1022a and generates a condensed activation map (or feature map) using a pooling function. Max-pooling is one example of a function performed by a pooling hidden layer. Other forms of pooling functions be used by the pooling hidden layer 1022a, such as average pooling, L2-norm pooling, or other suitable pooling functions. A pooling function (e.g., a max-pooling filter, an L2-norm filter, or other suitable pooling filter) is applied to eIctivation map included in the convolutional hidden layer 1022a. In the example shown in FIG. 10, three pooling filters are used for the three activation maps in the convolutional hidden layer 1022a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1022a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1022a having a dimension of 24×24 nodes, the output from the pooling hidden layer 1022b will be an array of 18×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1000.

The final layer of connections in the network is a fully-connected layer that connects every node from the pooling hidden layer 1022b to every one of the output nodes in the output layer 1024. Using the example above, the input layer includes 28×28 nodes encoding the pixel intensities of the input image, the convolutional hidden layer 1022a includes 3×24×24 hidden feature nodes based on application of a 5×5 local receptive field (for the filters) to three activation maps, and the pooling hidden layer 1022b includes a layer of 3×12×12 hidden feature nodes based on application of max-pooling filter to 2×2 regions across each of the three feature maps. Extending this example, the output layer 1024 can include ten output nodes. In such an example, every node of the 3×12×12 pooling hidden layer 1022b is connected to every node of the output layer 1024.

The fully connected layer 1022c can obtain the output of the previous pooling hidden layer 1022b (which should represent the activation maps of high-level features) and determines the features that most correlate to a particular class. For example, the fully connected layer 1022c layer can determine the high-level features that most strongly correlate to a particular class, and can include weights (nodes) for the high-level features. A product can be computed between the weights of the fully connected layer 1022c and the pooling hidden layer 1022b to obtain probabilities for the different classes. For example, if the CNN 1000 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1024 can include an M-dimensional vector (in the prior example, M=10). M indicates the number of classes that the CNN 1000 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

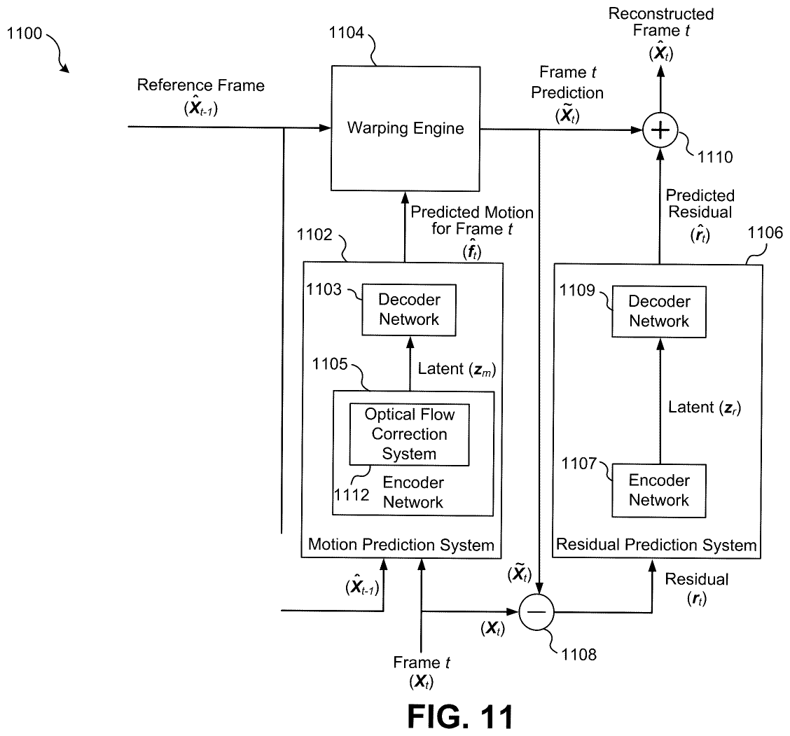

FIG. 11 is a diagram illustrating an example of a system 1100 utilizing optical flow to encode video frames (e.g., a neural P-frame coding system). As illustrated, the example system 1100 includes a motion prediction system 1102, a warping engine 1104, and a residual prediction system 1106. The motion prediction system 1102 and the residual prediction system 1106 can include any type of machine learning system (e.g., using one or more neural networks and/or other machine learning models, architectures, networks, etc.).

In some aspects, the motion prediction system 1102 can include one or more machine learning systems, which in some cases can include a neural network (e.g., one or more autoencoders, deep neural networks (DNNs), convolutional neural networks (CNNs), transformer neural networks, diffusion neural networks, any combination thereof, and/or other type of neural network). In one illustrative example, the encoder network 1105 and the decoder network 1103 of motion prediction system 1102 can be implemented as an autoencoder (e.g., also referred to as a “motion autoencoder” or “motion AE”). In some cases, the motion prediction system 1102 can be used to implement an optical flow correction technique. For instance, the encoder network 1105 can include an optical flow correction system 1112, which can perform an optical flow motion estimation technique. For example, the optical flow correction system 1112 can perform the techniques described above with respect to the optical flow correction system 400 of FIG. 4 and/or the optical flow correction system 500 illustrated in FIG. 5. In some aspects, the residual prediction system 1106 can include one or more machine learning systems, which in some cases can include a neural network (e.g., one or more autoencoders, deep neural networks (DNNs), convolutional neural networks (CNNs), transformer neural networks, diffusion neural networks, any combination thereof, and/or other type of neural network). In one illustrative example, the encoder network 1107 and the decoder network 1109 of residual prediction system 1106 can be implemented as an autoencoder (e.g., also referred to as a “residual autoencoder” or “residual AE”). While the example P-frame coding system 1100 of FIG. 11 is shown to include certain components, one of ordinary skill will appreciate that the example P-frame coding system 1100 can include fewer or more components than those shown in FIG. 11.

In one illustrative example, for a given time t, the system 1100 can receive an input frame Xₜ and a reference frame \hat{X}ₜ₋₁. In some aspects, the reference frame \hat{X}ₜ₋₁ can be a previously reconstructed frame (e.g., as indicated by the hat operator “*”) generated prior to time t (e.g., at time t−1). Input frame Xₜ and reference frame \hat{X}ₜ₋₁ can be associated with or otherwise obtained from the same sequence of video data (e.g., as consecutive frames, etc.). For example, the input frame Xₜ can be the current frame at time t, and the reference frame \hat{X}ₜ₋₁ can be a frame temporally or sequentially immediately prior to the input frame Xₜ. In some cases, the reference frame \hat{X}ₜ₋₁ may be received from a decoded picture buffer (DPB) of the example system 1100. In some cases, the input frame Xₜ can be a P-frame and the reference frame \hat{X}ₜ₋₁ can be an I-frame, a P-frame, or a B-frame. For example, the reference frame \hat{X}ₜ₋₁ can be previously reconstructed or generated by an I-frame coding system (e.g., which can be part of a device which includes the P-frame coding system 1100 or a different device than that which includes the P-frame coding system 1100), by the P-frame coding system 1100 (or a P-frame coding system of a device other than that which includes the P-frame coding system 1100), or by a B-frame coding system (e.g., which can be part of a device which includes the P-frame coding system 1100 or a different device than that which includes the P-frame coding system 1100).

As depicted in FIG. 11, motion prediction system 1102 receives as input reference frame \hat{X}ₜ₋₁ and the current (e.g., input) frame Xₜ. Motion prediction system 1102 can determine motion (e.g., represented by vectors, such as optical flow motion vectors) between pixels of reference frame \hat{X}ₜ₋₁ and pixels of input frame Xₜ. As described above (e.g., with respect to FIG. 4 and/or FIG. 5), the optical flow correction system 1112 can generate a corrected optical flow (e.g., optical flow 560) using the techniques described herein). Motion prediction system 1102 can then encode, and in some cases decode, this determined motion as a predicted motion \hat{f}ₜ for input frame Xₜ.

For example, an encoder network 1105 of motion prediction system 1102 can be used to determine motion (e.g., motion information) between current frame Xₜ and reference frame \hat{X}ₜ₋₁. The optical flow correction system 1112 can generate a corrected version of the motion information (e.g., optical flow 560) using the techniques described herein (e.g., as discussed with respect to FIG. 4 and/or FIG. 5). In some aspects, encoder network 1105 can encode the determined motion information into a latent representation (e.g., denoted as latent zₘ). For example, in some cases encoder network 1105 can map the determined motion information to a latent code, which can be used as the latent zₘ. Encoder network 1105 can additionally, or alternatively, convert the latent zₘ into a bitstream by performing entropy coding on the latent code associated with zₘ. In some examples, encoder network 1105 can quantize the latent zₘ (e.g., prior to entropy coding being performed on the latent code). The quantized latent can include a quantized representation of the latent zₘ. In some cases, the latent zₘ can include neural network data (e.g., a neural network node's activation map or feature map) that represents one or more quantized codes.

In some aspects, encoder network 1105 can store the latent zₘ, send the latent zₘ to a decoder network 1103 included in motion prediction system 1102, and/or can send the latent zₘ to another device or system that can decode the latent zₘ. Upon receiving the latent zₘ, decoder network 1103 can decode (e.g., inverse entropy code, dequantize, and/or reconstruct) the latent zₘ to generate a predicted motion \hat{f}ₜ between pixels of reference frame \hat{X}ₜ₋₁ and pixels of input frame Xₜ. For example, decoder network 1103 can decode the latent zₘ to generate an optical flow map \hat{f}ₜ that includes one or more motion vectors mapping some (or all) of the pixels included in reference frame \hat{X}ₜ₋₁ to pixels of input frame Xₜ. Encoder network 1105 and decoder network 1103 can be trained and optimized using training data (e.g., training images or frames) and one or more loss functions, as will be described in greater depth below.

In one illustrative example, encoder network 1105 and decoder network 1103 can be included in one or more machine learning systems, which in some cases can include a neural network (e.g., one or more autoencoders, deep neural networks (DNNs), convolutional neural networks (CNNs), transformer neural networks, diffusion neural networks, any combination thereof, and/or other type of neural network). The encoder network 1105 can include one or more components for quantizing the latent zₘ (e.g., generated as output by encoder network 1105 of the motion prediction system 1102) and converting the quantized latent into a bitstream. The bitstream generated from the quantized latent can be provided as input to decoder 1103 of the motion prediction system 1102.

In some examples, predicted motion \hat{f}ₜ can include optical flow information or data (e.g., an optical flow map including one or more motion vectors), dynamic convolution data (e.g., a matrix or kernel for data convolution), or block-based motion data (e.g., a motion vector for each block). In one illustrative example, predicted motion \hat{f}ₜ can include an optical flow map. In some cases, as described previously, an optical flow map \hat{f}ₜ can include a motion vector for each pixel of input frame Xₜ (e.g., a first motion vector for a first pixel, a second motion vector for a second pixel, and so on). The motion vectors can represent the motion information determined (e.g., by encoder network 1105) for the pixels in current frame Xₜ relative to corresponding pixels in reference frame \hat{X}ₜ₋₁.

The warping engine 1104 of system 1100 can obtain the optical flow map \hat{f}ₜ generated as output by motion prediction system 1102 (e.g., generated as output by decoder network 1103). For example, warping engine 1104 can retrieve optical flow map \hat{f}ₜ from storage or can receive optical flow map \hat{f}ₜ from motion prediction system 1102 directly. Warping engine 1104 can use optical flow map \hat{f}ₜ to warp (e.g., by performing motion compensation) the pixels of reference frame \hat{X}ₜ₋₁, resulting in the generation of a warped frame \tilde{X}ₜ. In some aspects, warped frame \tilde{X}ₜ can also be referred to as a motion compensated frame \tilde{X}ₜ (e.g., generated by warping the pixels of reference frame \hat{X}ₜ₋₁ based on the corresponding motion vectors included in optical flow map \hat{f}ₜ). For example, warping engine 1104 can generate motion compensated frame \tilde{X}ₜ by moving the pixels of reference frame \hat{X}ₜ₋₁ to new locations based on the motion vectors (and/or other motion information) included in optical flow map \hat{f}ₜ.

As noted above, to generate warped frame \tilde{X}ₜ, system 1100 can perform motion compensation by predicting an optical flow \hat{f}ₜ between input frame Xₜ and reference frame \hat{X}ₜ₋₁, and subsequently generating a motion compensated frame \tilde{X}ₜ by warping reference frame \hat{X}ₜ₋₁ using the optical flow map \hat{f}ₜ. However, in some cases, the frame prediction (e.g., motion-compensated frame \tilde{X}ₜ) generated based on optical flow map \hat{f}ₜ may not be accurate enough to represent input frame Xₜ as a reconstructed frame \hat{X}ₜ. For example, there may be one or more occluded areas in a scene depicted by input frame Xₜ, excessive lighting, lack of lighting, and/or other effects that results in the motion-compensated frame \tilde{X}ₜ not being accurate enough to for use as a reconstructed input frame \hat{X}ₜ.

Residual prediction system 1106 can be used to correct or otherwise refine the prediction associated with motion-compensated frame \tilde{X}ₜ. For example, residual prediction system 1106 can generate one or more residuals that system 1100 can subsequently combine with motion-compensated frame \tilde{X}ₜ in order to thereby generate a more accurate reconstructed input frame \hat{X}ₜ (e.g., a reconstructed input frame \hat{X}ₜ that more accurately represents the underlying input frame Xₜ). In one illustrative example, as depicted in FIG. 11, system 1100 can determine a residual rₜ by subtracting the predicted (e.g., motion-compensated) frame \tilde{X}ₜ from input frame Xₜ (e.g., determined using a subtraction operation 1108). For example, after the motion-compensated predicted frame \tilde{X}ₜ is determined by warping engine 1104, P-frame coding system 1100 can determine the residual rₜ by determining the difference (e.g., using subtraction operation 1108) between motion-compensated predicted frame \tilde{X}ₜ and input frame Xₜ.

In some aspects, an encoder network 1107 of residual prediction system 1106 can encode the residual rₜ into a latent zᵣ, where the latent zᵣ represents the residual rₜ. For example, encoder network 1107 can map the residual rₜ to a latent code, which can be used as the latent zᵣ. In some cases, encoder network 1107 can convert the latent zᵣ into a bitstream by performing entropy coding on the latent code. In some examples, encoder network 1107 can additionally, or alternatively, quantize the latent zᵣ (e.g., before entropy coding is performed). The quantized latent zᵣ can include a quantized representation of the residual rₜ. In some cases, the latent zᵣ can include neural network data (e.g., a neural network node's activation map or feature map) that represents one or more quantized codes. In some aspects, encoder network 1107 can store the latent zᵣ, transmit or otherwise provide the latent zᵣ to a decoder network 1109 of residual prediction system 1106, and/or can send the latent zᵣ to another device or system that can decode the latent zᵣ. Upon receiving the latent zᵣ, decoder network 1109 can decode the latent zᵣ (e.g., inverse entropy code, dequantize, and/or reconstruct) to generate a predicted (e.g., decoded) residual \hat{r}t. In some examples, encoder network 1107 and decoder network 1109 can be trained and optimized using training data (e.g., training images or frames) and one or more loss functions, as described below.

In one illustrative example, encoder network 1107 and decoder network 1109 can be included in a residual prediction autoencoder. The residual autoencoder can include one or more components for quantizing the latent zᵣ (e.g., where the latent zᵣ is generated as output by encoder network 1107 of the residual autoencoder) and converting the quantized latent into a bitstream. The bitstream generated from the quantized latent zᵣ can be provided as input to decoder 1109 of the residual autoencoder.

The predicted residual \hat{r}ₜ (e.g., generated by decoder network 1109 and/or a residual autoencoder used to implement residual prediction system 1106) can be used with the motion-compensated predicted frame \tilde{X}ₜ (e.g., generated by warping engine 1104 using the optical flow map \hat{f}ₜ generated by decoder network 1103) to generate a reconstructed input frame \hat{X}ₜ representing the input frame Xₜ at time t.

For example, system 1100 can add (e.g., using addition operation 1110) or otherwise combine the predicted residual ît and the motion-compensated predicted frame \tilde{X}ₜ to generate the reconstructed input frame \hat{X}ₜ. In some cases, decoder network 1109 of residual prediction system 1106 can add the predicted residual \hat{r}t to the motion-compensated frame prediction \tilde{X}ₜ. In some examples, reconstructed input frame \hat{X}ₜ may also be referred to as a decoded frame and/or a reconstructed current frame. The reconstructed current frame \hat{X}ₜ can be output for storage (e.g., in a decoded picture buffer (DPB) or other storage), transmission, display, for further processing (e.g., as a reference frame in further inter-predictions, for post-processing, etc.), and/or for any other use.

In one illustrative example, P-frame coding system 1100 can transmit the latent data representing an optical flow map or other motion information (e.g., the latent zₘ) and the latent data representing the residual information (e.g., the latent zᵣ) in one or more bitstreams to another device for decoding. In some cases, the other device can include a video decoder configured to decode the latents zₘ and zᵣ. In one illustrative example, the other device can include a video decoder implementing one or more portions of P-frame coding system 1100, motion prediction system 1102, and/or residual prediction system 1106 (e.g., a residual autoencoder), as described above.

The other device or video decoder can decode the optical flow map \hat{f}ₜ and/or other predicted motion information using the latent zₘ generated as output by the decoder network 1103 included in motion prediction system 1102. The other device or video decoder can additionally decode the residual \hat{r}t using the latent zᵣ generated as output by the decoder network 1109 included in residual prediction system 1106 (e.g., generated as output by a residual autoencoder that includes decoder network 1109). The other device or video decoder can subsequently use the optical flow map \hat{f}ₜ and the residual \hat{f}ₜ to generate the decoded (e.g., reconstructed) input frame \hat{X}ₜ.

For example, when the video decoder implements a same or similar architecture to that of the P-frame coding system 1100 described above, the video decoder can include a warping engine (e.g., the same as or similar to warping engine 1104) that receives as input the decoded optical flow map \hat{f}ₜ and the reference frame \hat{X}ₜ₋₁. The video decoder warping engine can warp reference frame \hat{X}ₜ₋₁ based on motion vectors and/or other motion information determined for some (or all) of the pixels of reference frame \hat{X}ₜ₋₁, based on the decoded optical flow map \hat{f}ₜ. The video decoder warping engine can output a motion-compensated frame prediction \tilde{X}ₜ (e.g., as described above with respect to the output of warping engine 1104). The video decoder can subsequently add or otherwise combine the decoded residual \hat{r}t and the motion-compensated frame prediction \tilde{X}ₜ to generate the decoded (e.g., reconstructed) input frame \hat{X}ₜ (e.g., as described above with respect to the output of addition operation 1110).

In some examples, motion prediction system 1102 and/or residual prediction system 1106 can be trained and/or optimized using training data and one or more loss functions. In some cases, motion prediction system 1102 and/or residual prediction system 1106 can be trained in an end-to-end manner (e.g., where all neural network components are trained during the same training process). In some aspects, the training data can include a plurality of training images and/or training frames. In some cases, a loss function (e.g., Loss) can be used to perform training, based on motion prediction system 1102 and/or residual prediction system 1106 processing the training images or frames.

In one example, the loss function (e.g., Loss) can be given as Loss=D+βR, where D is a distortion between a given frame (e.g., such as input frame Xₜ) and its corresponding reconstructed frame (e.g., \hat{X}ₜ). For example, the distortion D can be determined as D(Xₜ, \hat{X}ₜ). β is a hyperparameter that can be used to control a bitrate (e.g., bits per pixel), and R is a quantity of bits used to convert the residual (e.g., residual rₜ) to a compressed bitstream (e.g., latent zᵣ). In some examples, the distortion D can be calculated based on one or more of a peak signal-to-noise ratio (PSNR), a structural similarity index measure (SSIM), a multiscale SSIM (MS-SSIM), and/or the like. In some aspects, using one or more training data sets and one or more loss functions, parameters (e.g., weights, biases, etc.) of motion prediction system 1102 and/or residual prediction system 1106 can be tuned until a desired video coding result is achieved by example system 1100.

In some aspects, training of one or more of the machine learning systems or neural networks described herein (e.g., such as the system 400 of FIG. 4, the system 500 of FIG. 5, the deep learning network 900 of FIG. 9, the CNN 1000 of FIG. 10, the system 1100 of FIG. 11, etc.) can be performed using online training, offline training, and/or various combinations of online and offline training. In some cases, online may refer to time periods during which the input data (e.g., such as the image 502 of FIG. 5, etc.) is processed, for instance for performance of the disparity correction processing (e.g., optical flow correction, etc.) implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others.

FIG. 12 is a diagram illustrating an example of a system for implementing certain aspects of the present technology. In particular, FIG. 12 illustrates an example of computing system 1200, which can be for example any computing device making up internal computing system, a remote computing system, a camera, or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some aspects, computing system 1200 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1200 includes at least one processing unit (CPU or processor) 1210 and connection 1205 that couples various system components including system memory 1215, such as ROM 1220 and RAM 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some aspects, a hardware service that performs a particular function can include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 800, and/or other process described herein) may be performed by a computing device or apparatus. In one example, the process 800 can be performed by a computing device (e.g., image capture and processing system 200 in FIG. 2) having a computing architecture of the computing system 1200 shown in FIG. 12.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative Aspects of the present disclosure include:
Aspect 1. An apparatus for processing one or more images, comprising: one or more memories configured to store the one or more images; and one or more processors coupled to one or more memories and configured to: obtain first disparity information associated with a current image of the one or more images; warp the current image based on the first disparity information to obtain an estimated previous image; determine a confidence map associated with a confidence of the first disparity information based on a difference associated with the estimated previous image; and apply the confidence map to the first disparity information to generate updated first disparity information.
Aspect 2. The apparatus of Aspect 1, wherein the first disparity information comprises at least one of a first disparity information estimating a first movement of a first feature to a first destination location in the current image or depth information representing a depth of the first feature.
Aspect 3. The apparatus of any of Aspects 1 to 2, wherein the one or more processors are configured to determine the difference between a previous image and the estimated previous image.
Aspect 4. The apparatus of any of Aspects 1 to 3, the confidence map comprises a first region corresponding to the first feature that is valid in the first disparity information.
Aspect 5. The apparatus of any of Aspects 1 to 4, the confidence map comprises a first region corresponding to the first feature that is a false positive in the first disparity information.
Aspect 6. The apparatus of any of Aspects 1 to 5, wherein the one or more processors are configured to: remove the first disparity information to generate the updated first disparity information.
Aspect 7. The apparatus of any of Aspects 1 to 6, the confidence map is determined based on a first threshold at a first time, and wherein the confidence map is determined based on a second threshold at a second time after the first time.
Aspect 8. The apparatus of any of Aspects 1 to 7, the second threshold comprises a higher confidence than the first threshold.
Aspect 9. The apparatus of any of Aspects 1 to 8, wherein the one or more processors are configured to: determine a sparsity of a region associated with the first feature in the current image or a previous image; and determine, based on the sparsity, a threshold corresponding to a confidence of the first feature in the first disparity information.
Aspect 10. The apparatus of any of Aspects 1 to 9, wherein the one or more processors are configured to: determine a first movement magnitude associated with the first feature in the current image; determine, based on the first movement magnitude, a first threshold corresponding to a confidence of the first feature within the first disparity information; and determine, based on the first threshold, whether a region in the confidence map associated with the first feature corresponds to an authentic disparity information.
Aspect 11. The apparatus of any of Aspects 1 to 10, wherein the one or more processors are configured to: determine an attention associated with the first feature, wherein the attention corresponds to an importance of the first feature in association with at least one other feature in the first disparity information; and determine a first threshold corresponding to an authentication of the first disparity information of the first feature based on the attention.
Aspect 12. The apparatus of any of Aspects 1 to 11, the attention comprises information identifying the importance of the first feature within a previous image and the current image as compared to other features within the previous image and the current image.
Aspect 13. The apparatus of any of Aspects 1 to 12, wherein the one or more processors are configured to: obtain a second disparity information associated with a previous image, the second disparity information estimating a second movement of the first feature within the current image or the previous image.
Aspect 14. The apparatus of any of Aspects 1 to 13, wherein the one or more processors are configured to: determine that the first feature is occluded in the current image or the previous image based on the first disparity information and the second disparity information.
Aspect 15. The apparatus of any of Aspects 1 to 14, wherein the one or more processors are configured to: warp the previous image based on the second disparity information to obtain an estimated current image; generate a second confidence map associated with the second disparity information based on a difference associated the estimated current image; and apply the second confidence map to the second disparity information to generate updated second disparity information.
Aspect 16. The apparatus of any of Aspects 1 to 15, further comprising one or more cameras configured to capture the one or more images.
Aspect 17. The apparatus of any of Aspects 1 to 16, wherein, to obtain the first disparity information associated with the current image, the one or more processors are configured to: generate, using one or more machine learning systems, features representing the current image; and generate, based on the features representing the current image, the first disparity information.
Aspect 18. The apparatus of Aspect 17, wherein the one or more machine learning systems comprise at least one of a deep neural network (DNN) or a convolutional neural network (CNN).
Aspect 19. A method of processing one or more images by an image capturing device, comprising: obtaining first disparity information associated with a current image, the first disparity information estimating a first movement of a first feature to a first destination location in the current image; warping the current image based on the first optical flow information to obtain an estimated previous image; determining a confidence map associated with a confidence of the first disparity information based on a difference associated with the estimated previous image; and applying the confidence map to the first disparity information to generate updated first disparity information.
Aspect 20. The method of Aspect 19, further comprising determining the difference between a previous image and the estimated previous image.
Aspect 21. The method of any of Aspects 19 to 20, wherein the confidence map comprises a first region corresponding to the first feature that is valid in the first disparity information.
Aspect 22. The method of any of Aspects 19 to 21, wherein the confidence map comprises a first region corresponding to the first feature that is a false positive in the first disparity information.
Aspect 23. The method of any of Aspects 19 to 22, wherein applying the confidence map to the first disparity information comprises removing the first disparity information to generate the updated first disparity information.
Aspect 24. The method of any of Aspects 19 to 23, wherein the confidence map is determined based on a first threshold at a first time, and wherein the confidence map is determined based on a second threshold at a second time after the first time.
Aspect 25. The method of any of Aspects 19 to 24, wherein the second threshold comprises a higher confidence than the first threshold.
Aspect 26. The method of any of Aspects 19 to 25, wherein generating the confidence map comprises: determining a sparsity of a region associated with the first feature in the current image or a previous image; and determining, based on the sparsity, a threshold corresponding to a confidence of the first feature in the first disparity information.
Aspect 27. The method of any of Aspects 19 to 26, wherein generating the confidence map comprises: determining a first movement magnitude associated with the first feature in the current image; determining, based on the first movement magnitude, a first threshold corresponding to a confidence of the first feature within the first disparity information; and determining, based on the first threshold, whether a region in the confidence map associated with the first feature corresponds to an authentic disparity information.
Aspect 28. The method of any of Aspects 19 to 27, wherein generating the confidence map comprises: determining an attention associated with the first feature, wherein the attention corresponds to an importance of the first feature in association with at least one other feature in the first disparity information; and determining a first threshold corresponding to an authentication of the first disparity information of the first feature based on the attention.
Aspect 29. The method of any of Aspects 19 to 28, wherein the attention comprises information identifying the importance of the first feature within a previous image and the current image as compared to other features within the previous image and the current image.
Aspect 30. The method of any of Aspects 19 to 29, further comprising: obtaining a second disparity information associated with a previous image, the second disparity information estimating a second movement of the first feature within the current image or the previous image.
Aspect 31. The method of any of Aspects 19 to 30, further comprising: determining that the first feature is occluded in the current image or the previous image based on the updated first disparity information and the second disparity information.
Aspect 32. The method of any of Aspects 19 to 31, further comprising: warping the previous image based on the second disparity information to obtain an estimated current image; generating a second confidence map associated with the second disparity information based on a difference associated the estimated current image; and applying the second confidence map to the second disparity information to generate updated second disparity information.
Aspect 33. The method of any of Aspects 19 to 32, wherein the first disparity information comprises at least one of a first optical flow information estimating a first movement of a first feature to a first destination location in the current image or depth information representing a depth of the first feature.
Aspect 34. The apparatus of any of Aspects 19 to 33, wherein, to obtain the first disparity information associated with the current image, the one or more processors are configured to: generate, using one or more machine learning systems, features representing the current image; and generate, based on the features representing the current image, the first disparity information.
Aspect 35. The apparatus of Aspect 34, wherein the one or more machine learning systems comprise at least one of a deep neural network (DNN) or a convolutional neural network (CNN).
Aspect 36. A non-transitory computer-readable medium having stored thereon instructions that, when executed by at least one processor, cause the at least one processor to perform operations according to any of Aspects 19 to 45.
Aspect 37. An apparatus for processing one or more images, comprising one or more means for performing operations according to any of Aspects 19 to 45.

What is claimed is:

1. An apparatus for processing one or more images, comprising:
one or more memories configured to store the one or more images; and
one or more processors coupled to the one or more memories and configured to:
obtain first disparity information associated with a current image of the one or more images;
warp the current image based on the first disparity information to obtain an estimated previous image;
determine a confidence map associated with a confidence of the first disparity information based on a difference associated with the estimated previous image; and
apply the confidence map to the first disparity information to generate updated first disparity information.

2. The apparatus of claim 1, wherein the first disparity information comprises at least one of a first optical flow information estimating a first movement of a first feature to a first destination location in the current image or depth information representing a depth of the first feature.

3. The apparatus of claim 1, wherein the one or more processors are configured to determine the difference between a previous image and the estimated previous image.

4. The apparatus of claim 1, wherein the confidence map comprises a first region corresponding to a first feature that is valid in the first disparity information.

5. The apparatus of claim 1, wherein the confidence map comprises a first region corresponding to a first feature that is a false positive in the first disparity information.

6. The apparatus of claim 5, wherein the one or more processors are configured to:
remove the first disparity information to generate the updated first disparity information.

7. The apparatus of claim 1, wherein the confidence map is determined based on a first threshold at a first time, and wherein the confidence map is determined based on a second threshold at a second time after the first time.

8. The apparatus of claim 7, wherein the second threshold comprises a higher confidence than the first threshold.

9. The apparatus of claim 1, wherein the one or more processors are configured to:
determine a sparsity of a region associated with a first feature in the current image or a previous image; and
determine, based on the sparsity, a threshold corresponding to a confidence of the first feature in the first disparity information.

10. The apparatus of claim 1, wherein the one or more processors are configured to:
determine a first movement magnitude associated with a first feature in the current image;
determine, based on the first movement magnitude, a first threshold corresponding to a confidence of the first feature within the first disparity information; and
determine, based on the first threshold, whether a region in the confidence map associated with the first feature corresponds to an authentic disparity information.

11. The apparatus of claim 1, wherein the one or more processors are configured to:
determine an attention associated with a first feature, wherein the attention corresponds to an importance of the first feature in association with at least one other feature in the first disparity information; and
determine a first threshold corresponding to an authentication of the first disparity information of the first feature based on the attention.

12. The apparatus of claim 11, wherein the attention comprises information identifying the importance of the first feature within a previous image and the current image as compared to other features within the previous image and the current image.

13. The apparatus of claim 1, wherein the one or more processors are configured to:
obtain a second disparity information associated with a previous image, the second disparity information estimating a second movement of a first feature within the current image or the previous image.

14. The apparatus of claim 13, wherein the one or more processors are configured to:
determine that the first feature is occluded in the current image or the previous image based on the first disparity information and the second disparity information.

15. The apparatus of claim 13, wherein the one or more processors are configured to:
warp the previous image based on the second disparity information to obtain an estimated current image;
generate a second confidence map associated with the second disparity information based on a difference associated the estimated current image; and
apply the second confidence map to the second disparity information to generate updated second disparity information.

16. The apparatus of claim 1, further comprising one or more cameras configured to capture the one or more images.

17. The apparatus of claim 1, wherein, to obtain the first disparity information associated with the current image, the one or more processors are configured to:
generate, using one or more machine learning systems, features representing the current image; and
generate, based on the features representing the current image, the first disparity information.

18. The apparatus of claim 17, wherein the one or more machine learning systems comprise at least one of a deep neural network (DNN) or a convolutional neural network (CNN).

19. A method of processing one or more images by an image capturing device, comprising:
obtaining first disparity information associated with a current image;
warping the current image based on the first disparity information to obtain an estimated previous image;
determining a confidence map associated with a confidence of the first disparity information based on a difference associated with the estimated previous image; and
applying the confidence map to the first disparity information to generate updated first disparity information.

20. The method of claim 19, wherein the first disparity information comprises at least one of a first optical flow information estimating a first movement of a first feature to a first destination location in the current image or depth information representing a depth of the first feature.
